(19) United States
(12) Patent Application Publication
(10) Pub. No.: US 2026/0173237 A1
(43) Pub. Date: Jun. 18, 2026

(54) LAMP CONTROL SYSTEM, LAMP CONTROL METHOD, AND VEHICLE

(71) Applicant: HYUNDAI MOBIS CO., LTD., Seoul (KR)

(72) Inventor: Jun Young SUNG, Yongin-si (KR)

(73) Assignee: HYUNDAI MOBIS CO., LTD., Seoul (KR)

(21) Appl. No.: 19/300,604

(22) Filed: Aug. 14, 2025

(30) Foreign Application Priority Data
Dec. 17, 2024 (KR) 10-2024-0188747

(51) Int. Cl. H05B 47/115; H05B 47/165; B60Q 1/14

(52) U.S. Cl. CPC H05B 47/115; H05B 47/165; B60Q 1/143; B60Q 2300/112; B60Q 2300/30

(57) ABSTRACT

A lamp control system, as a lamp control system for a moving object, includes: a lamp to emit a beam pattern; a memory to store driving environment data of the moving object, refined data obtained by analyzing the driving environment data of the moving object, and big data obtained by collecting and analyzing driving environment data of a plurality of other moving objects based on location information; and a processor to control the beam pattern based on one of the big data and the driving environment data of the moving object, and location information of the moving object.

### CROSS-REFERENCE TO RELATED APPLICATIONS

This application claims the benefit of Korean Patent Application No. 10-2024-0188747, filed on December 17, 2024, which is hereby incorporated by reference as if fully set forth herein.

### BACKGROUND

### Technical Field

The present embodiments are applicable to vehicles in all fields and, more particularly, relate to a lamp control system, lamp control method, and vehicle for controlling lamps for each driving section based on driving environment data.

### Discussion of the Related Art

As utilization of a lamp for a vehicle equipped with an LED light source continues to increase, a demand for high-beam and low-beam lamp modules for the vehicle with various performances is also growing. In particular, a trend of integrating the high-beam and low-beam modules for the vehicle is becoming a significant trend. This trend is well-received in the market because of low cost, small volume, simple structure, and a wide range of functions.

As people's interest in safety when driving the vehicle is increasing, a considerable number of driving accidents occur every year because of inappropriate use of the high-beams. A lamp module for the vehicle with an ADB (Adaptive Driving Beam) function may solve contradiction of high and low-beam use to some extent. In other words, it may provide excellent visibility to the vehicle and prevent glare to other vehicle drivers. The ADB function has a kind of smart control performance, and is able to control a lighting area and lighting brightness in real time by independently controlling each LED, thereby effectively preventing the glare to other vehicles and pedestrians.

Existing vehicles with the ADB function have been used in a way that a driver directly specifies a speed at which the ADB function is activated, and the ADB function is automatically activated when the vehicle travels at a speed equal to or higher than the corresponding speed. However, the existing scheme has a problem in that the lighting is controlled without considering an environment of a road on which the vehicle is traveling, so that the lighting becomes darker on a relatively dark road or becomes brighter in a relatively bright place, obstructing a view of the pedestrians or other drivers. In addition, the ADB function may be activated earlier than the driver wants, causing many malfunctions resulted from camera recognition errors, or an ADB function may be activated later than the driver wants, causing frustration.

In addition, even though the vehicle is equipped with the ADB function, there are frequent cases in which the driver does not recognize it and does not use the ADB function. Therefore, a scheme is needed that may automatically activate the ADB function based on the surrounding road environment and a driver's tendency.

### SUMMARY

Accordingly, the present disclosure is directed to a lamp control system, lamp control method, and vehicle that substantially obviate one or more problems due to limitations and disadvantages of the related art.

The present disclosure is aimed at solving the aforementioned problems, and according to the embodiments, an object of the present disclosure is to efficiently control the increase or reduction of the light intensity of a lamp based on the driving environment data of a moving object.

Furthermore, according to the embodiments, another object of the present disclosure is to efficiently control the increase or reduction of the light intensity of a lamp based on the driving environment data of not only a relevant moving object but also other multiple moving objects.

It will be appreciated by persons skilled in the art that the objects that could be achieved with the present disclosure are not limited to what has been particularly described hereinabove and the above and other objects that the present disclosure could achieve will be more clearly understood from the following detailed description.

To achieve these objects and other advantages and in accordance with the purpose of the disclosure, as embodied and broadly described herein, provided is a lamp control system for a moving object. The lamp control system includes: a lamp configured to emit a beam pattern; a memory configured to store driving environment data of the moving object, data obtained by refining and analyzing the driving environment data of the moving object, and big data obtained by collecting and analyzing driving environment data of a plurality of other moving objects based on location information; and a processor configured to control the beam pattern based on one of the big data, the driving environment data of the moving object and the data derived from the driving environment data, and location information of the moving object.

According to embodiments, the driving environment data may include driving distance information or driving time information of the moving object for each section corresponding to the driving environment data.

According to embodiments, the processor may be configured to control the beam pattern based on driving section information of the moving object corresponding to the location information of the moving object, and the driving section information may be indicated by one of the big data, the driving environment data and the data derived from the driving environment data.

According to embodiments, the processor may be configured to: in a case in which the driving section information indicated by the big data or the driving environment data corresponds to first section information, control to increase a light intensity or beam width of the beam pattern; and in a case in which the driving section information indicated by one of the big data, the driving environment data and the data derived from the driving environment data corresponds to second section information, control to reduce a light intensity or beam width of the beam pattern.

According to embodiments, the processor may be configured to control the beam pattern based on correlation information between first driving section information of the moving object and second driving section information, the first driving section information corresponding to the location information of the moving object indicated by the driving environment data or the data derived from the driving environment data and the second driving section information being based on global positioning system (GPS).

According to embodiments, the driving section information may be configured based on information on an average speed of the moving object, information on a continuous driving distance for each section, or information on a continuous driving time for each section, and the information on the continuous driving distance for each section and the information on the continuous driving time for each section may be included in the driving environment data corresponding to the location information of the moving object.

According to embodiments, the driving section information may be configured based on correlation information between the information on the continuous driving distance for each section and the information on the continuous driving time for each section.

According to embodiments, the processor may be configured to: in a case in which the big data is available, control the beam pattern based on the big data; and in a case in which the big data is unavailable, control the beam pattern based on the data.

In another aspect of the present disclosure, provided herein is a lamp control method for a moving object. The lamp control method is performed by a lamp control system having a lamp configured to emit a beam pattern in a forward direction and includes: acquiring one or more of driving environment data of the moving object, data obtained by refining and analyzing the driving environment data of the moving object, and big data obtained by collecting and analyzing driving environment data of a plurality of other moving objects based on location information; and controlling the beam pattern based on one of the big data, the driving environment data of the moving object and the data derived from the driving environment data, and location information of the moving object.

In a further aspect of the present disclosure, provided herein is a moving object. The moving object includes: a lamp configured to emit a beam pattern; a memory configured to store driving environment data of the moving object, data obtained by refining and analyzing the driving environment data of the moving object, and big data obtained by collecting and analyzing driving environment data of a plurality of other moving objects based on location information; and a processor configured to control the beam pattern based on one of the big data, the driving environment data of the moving object and the data derived from the driving environment data, and location information of the moving object.

As is apparent from the above description, the present disclosure has effects as follows.

According to the embodiments, the increase or reduction of the light intensity of a lamp may be efficiently controlled based on the driving environment data of a moving object, thereby efficiently controlling the lamp based on driving section information.

According to the embodiments, the increase or reduction of the light intensity of a lamp may be efficiently controlled based on the driving environment data of not only a relevant moving object but also other multiple moving objects, thereby efficiently controlling the lamp based on driving section information.

The effects obtainable from the present disclosure are not limited to those mentioned above. Other effects not explicitly mentioned will be clearly understood by those skilled in the art from the following description.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is an overall block diagram of an autonomous vehicle to which an autonomous driving device is applicable;

FIG. 2 is an exemplary diagram illustrating an example where an autonomous driving device is applied to a vehicle;

FIG. 3 is a block diagram of a lamp control system according to embodiments;

FIG. 4 illustrates data obtained by collecting and analyzing the usage history of a specific beam pattern of multiple moving objects based on location information;

FIGS. 5 and 6 are flowcharts of methods of controlling a beam pattern according to embodiments;

FIG. 7 is a detailed flowchart of step S610 step shown in FIG. 6, which is part of a lamp control method according to embodiments; and

FIG. 8 is a detailed flowchart of step S710 shown in FIG. 7, which is part of the lamp control method according to the embodiments.

### DETAILED DESCRIPTION

Preferred embodiments of embodiments will be described in detail, and examples of which will be illustrated in the accompanying drawings. The detailed description below with reference to the accompanying drawings is intended to describe the preferred embodiments of the embodiments rather than to illustrate only embodiments that may be implemented according to the embodiments. The detailed description below includes details to provide a thorough understanding of the embodiments. However, it will be apparent to one skilled in the art that the embodiments may be practiced without such details.

Most of terms used in the embodiments are generally chosen from those widely used in the art, but some terms are arbitrarily chosen by the applicant and meanings thereof are described in detail in the following description as necessary. Therefore, the embodiments should be understood based on the intended meanings of the terms, not on the mere names or meanings of the terms.

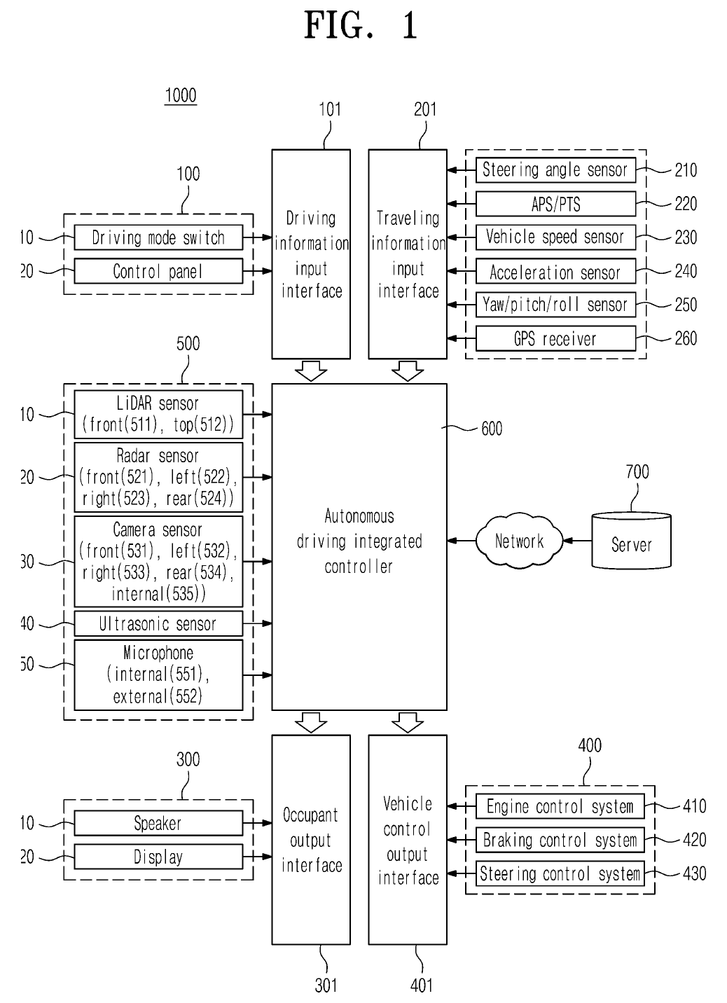

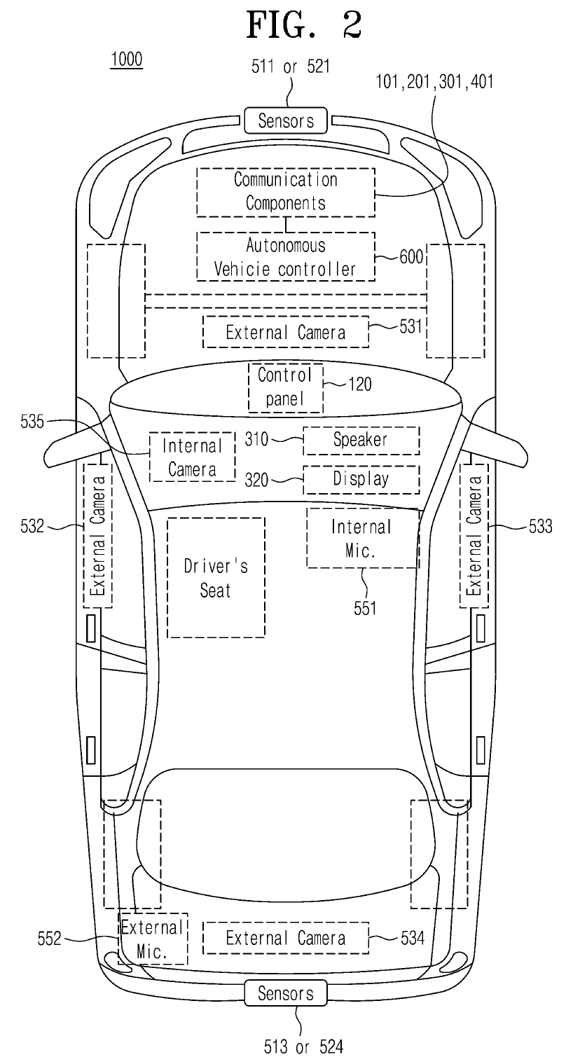

FIG. 1 is an overall block diagram of an autonomous vehicle to which an autonomous driving device is applicable. FIG. 2 is an exemplary diagram illustrating an example where an autonomous driving device is applied to a vehicle.

FIG. 2 illustrates a vehicle to which the vehicle system of FIG. 1 is applied.

The vehicle according to the embodiments may be configured as shown in FIG. 2 and may perform autonomous driving based on the autonomous driving control system. The vehicle according to the embodiments may be referred to as an autonomous driving vehicle, robot, Urban Air Mobility (UAM), autonomous driving device, etc.

First, with reference to FIGS. 1 and 2, the structure and function of an autonomous driving control system (e.g., autonomous vehicle) to which the autonomous driving device according to the present embodiments is applicable will be described.

As shown in FIG. 1, an autonomous vehicle 1000 may be implemented based on an autonomous driving integrated controller 600, which transmits and receives data necessary for the autonomous driving control of the autonomous vehicle through a driving information input interface 101, a travel information input interface 201, a passenger output interface 301, and an autonomous vehicle control output interface 401. However, the autonomous driving integrated controller 600 may be referred to simply as a controller, processor, or control unit in this specification.

The autonomous driving integrated controller 600 may obtain driving information based on the operation of a passenger on a user input unit 100 in an autonomous driving mode or a manual driving mode through the driving information input interface 101. As shown in FIG. 1, the user input unit 100 may include a driving mode switch 110 and a control panel 120 (for example, a navigation terminal mounted in the autonomous driving vehicle, a smartphone or tablet PC carried by the passenger, etc.). Accordingly, the driving information may include driving mode information of the autonomous driving vehicle and navigation information.

For example, a driving mode (i.e., autonomous driving mode/manual driving mode or sports mode/eco mode/safe mode/normal mode) of the autonomous vehicle determined based on passenger's manipulation of the driving mode switch 110 may be transmitted to the autonomous driving integrated controller 600 as the driving information via the driving information input interface 101.

In addition, the navigation information such as a passenger's destination and a route to the destination (the shortest route, a preferred route, or the like selected by the passenger among candidate routes to the destination) input by the passenger via the control panel 120 may be transmitted to the autonomous driving integrated controller 600 as the driving information via the driving information input interface 101.

In one example, the control panel 120 may be implemented as a touch screen panel that provides a user interface (UI) for the passenger to input or modify information for controlling the autonomous driving of the autonomous vehicle, and in this case, the driving mode switch 110 described above may be implemented as a touch button on the control panel 120.

In addition, the autonomous driving integrated controller 600 may obtain travel information indicating a travel state of the autonomous vehicle via the travel information input interface 201. The travel information may include various information indicating the travel state and a behavior of the autonomous vehicle, such as a steering angle formed by the passenger manipulating a steering wheel, an accelerator pedal stroke or a brake pedal stroke generated by pressing an accelerator pedal or a brake pedal, and a behavior of the autonomous vehicle including a vehicle speed, an acceleration, a yaw, a pitch, and a roll. Each of the travel information may be detected by a driving controller 200 including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the travel information of the autonomous vehicle may include location information of the autonomous vehicle, and the location information of the autonomous vehicle may be obtained via a global positioning system (GPS) receiver 260 applied to the autonomous vehicle. Such travel information may be transmitted to the autonomous driving integrated controller 600 via the travel information input interface 201 and used to control the travel of the autonomous vehicle in the autonomous driving mode or the manual driving mode of the autonomous vehicle.

In addition, the autonomous driving integrated controller 600 may transmit travel state information provided to the passenger in the autonomous driving mode or the manual driving mode of the autonomous vehicle to an output unit 300 via the passenger output interface 301. That is, the autonomous driving integrated controller 600 may transmit the travel state information of the autonomous vehicle to the output unit 300, thereby allowing the passenger to identify an autonomous driving state or a manual driving state of the autonomous vehicle based on the travel state information output via the output unit 300. The travel state information may include various information indicating the travel state of the autonomous vehicle, such as a current driving mode, a shift range, the vehicle speed, and the like of the autonomous vehicle.

In addition, when determining that a warning is necessary for the passenger in the autonomous driving mode or the manual driving mode of the autonomous vehicle together with the travel state information described above, the autonomous driving integrated controller 600 may transmit warning information to the output unit 300 via the passenger output interface 301, so that the output unit 300 may output the warning to the passenger. To output such travel state information and warning information audibly and visually, the output unit 300 may include a speaker 310 and a display device 320 as illustrated in FIG. 1. In this regard, the display device 320 may be implemented as the same device as the control panel 120 described above, or may be implemented as a separate, independent device.

In addition, the autonomous driving integrated controller 600 may transmit control information for controlling the travel of the autonomous vehicle in the autonomous driving mode or the manual driving mode of the autonomous vehicle to a lower control system 400 applied to the autonomous vehicle via the autonomous vehicle control output interface 401. The lower control system 400 for controlling the control of the autonomous vehicle may include an engine control system 410, a braking control system 420, and a steering control system 430 as illustrated in FIG. 1, and the autonomous driving integrated controller 600 may transmit engine control information, braking control information, and steering control information as the control information to each lower control system 410, 420, and 430 via the autonomous vehicle control output interface 401. Accordingly, the engine control system 410 may control the vehicle speed and the acceleration of the autonomous vehicle by increasing or decreasing an amount of fuel supplied to an engine, the braking control system 420 may control braking of the autonomous vehicle by adjusting a braking force of the autonomous vehicle, and the steering control system 430 may control steering of the autonomous vehicle via a steering device (e.g., a motor driven power steering (MDPS) system) applied to the autonomous vehicle.

As described above, the autonomous driving integrated controller 600 of the present embodiment may obtain the driving information based on the manipulation of the passenger and the travel information indicating the travel state of the autonomous vehicle via the driving information input interface 101 and the travel information input interface 201, respectively, may transmit the travel state information and the warning information generated based on an autonomous driving algorithm to the output unit 300 via the passenger output interface 301, and may operate such that the travel control of the autonomous vehicle is performed by transmitting the control information generated based on the autonomous driving algorithm to the lower control system 400 via the autonomous vehicle control output interface 401.

In one example, to ensure stable autonomous driving of the autonomous vehicle, it is necessary to continuously monitor the travel state by accurately measuring a travel environment of the autonomous vehicle and control the travel based on the measured travel environment. To this end, the autonomous driving device of the present embodiment may include a sensing module 500 for detecting an object surrounding the autonomous vehicle, such as a surrounding autonomous vehicle, the pedestrian, the road, or a fixed facility (e.g., a traffic light, a milestone, a traffic sign, a construction fence, and the like), as illustrated in FIG. 1.

The sensing module 500 may include one or more of a lidar sensor 510, a radar sensor 520, and a camera sensor 530 for detecting the surrounding object outside the autonomous vehicle as illustrated in FIG. 1.

The lidar sensor 510 may detect the surrounding object outside the autonomous vehicle by transmitting a laser signal to surroundings of the autonomous vehicle and receiving a signal reflected from the corresponding object and returned, and may detect the surrounding object located within predefined set distance, set vertical field of view, and set horizontal field of view based on specifications thereof. The lidar sensor 510 may include a front lidar sensor 511, an upper lidar sensor 512, and a rear lidar sensor 513 installed on a front surface, an upper portion, and a rear surface of the autonomous vehicle, respectively, but the installation locations and the number of installed units thereof are not limited to those in a specific embodiment. A threshold value for determining validity of the laser signal reflected from the corresponding object and returned may be stored in advance in a memory (not shown) of the autonomous driving integrated controller 600, and the autonomous driving integrated controller 600 may determine a location (including a distance to the corresponding object), a speed, and a moving direction of the corresponding object by measuring a time it takes for the laser signal transmitted via the lidar sensor 510 to be reflected from the corresponding object and returned.

The radar sensor 520 may detect the surrounding object outside the autonomous vehicle by emitting an electromagnetic wave to surroundings of the autonomous vehicle and receiving a signal reflected from the corresponding object and returned, and may detect the surrounding object located within the predefined set distance, set vertical angle of view, and set horizontal angle of view range based on specifications thereof. The radar sensor 520 may include a front radar sensor 521, a left radar sensor 521, a right radar sensor 522, and a rear radar sensor 523 installed on the front surface, a left side surface, a right side surface, and the rear surface of the autonomous vehicle, respectively, but the installation locations and the number of installed units thereof are not limited to those in a specific embodiment. The autonomous driving integrated controller 600 may determine the location (including the distance to the corresponding object), the speed, and the moving direction of the corresponding object by analyzing power of the electromagnetic wave transmitted and received via the radar sensor 520.

The camera sensor 530 may detect the surrounding object outside the autonomous vehicle by capturing the surroundings of the autonomous vehicle, and may detect the surrounding object located within the predefined set distance, set vertical field of view, and set horizontal field of view based on specifications thereof.

The camera sensor 530 may include a front camera sensor 531, a left camera sensor 532, a right camera sensor 533, and a rear camera sensor 534 installed on the front surface, the left side surface, the right side surface, and the rear surface of the autonomous vehicle, respectively, but the installation locations and the number of installed units thereof are not limited to those in a specific embodiment. The autonomous driving integrated controller may determine the location (including the distance to the corresponding object), the speed, the moving direction, and the like of the corresponding object by applying predefined image processing to the image captured via the camera sensor 530.

In addition, an internal camera sensor 535 for capturing interior of the autonomous vehicle may be mounted at a predetermined location (e.g., a rearview mirror) inside the autonomous vehicle, and the autonomous driving integrated controller 600 may monitor a behavior and a state of the passenger based on the image obtained via the internal camera sensor 535 and output a guidance or the warning to the passenger via the output unit 300 described above.

In addition to the lidar sensor 510, the radar sensor 520, and the camera sensor 530, the sensing module 500 may further include an ultrasonic sensor 540 as illustrated in FIG. 1, and various types of sensors for detecting the surrounding object of the autonomous vehicle may be further employed in the sensing module 500.

To help understand the present embodiment, FIG. 2 shows an example in which the front lidar sensor 511 or the front radar sensor 521 is installed on the front surface of the autonomous vehicle, the rear lidar sensor 513 or the rear radar sensor 523 is installed on the rear surface of the autonomous vehicle, and the front camera sensor 531, the left camera sensor 532, the right camera sensor 533, and the rear camera sensor 534 are installed on the front surface, the left side surface, the right side surface, and the rear surface of the autonomous vehicle, respectively. However, as described above, the installation locations and the number of installed units of the respective sensors are not limited to those in a specific embodiment.

In addition, the sensing module 500 may further include a bio-sensor for detecting bio-signals of the passenger (e.g., heart rate, electrocardiogram, respiration, blood pressure, body temperature, brain wave, blood flow (pulse wave), blood sugar, and the like) to determine the state of the passenger in the autonomous vehicle. The bio-sensor may include a heart rate sensor, an electrocardiogram sensor, a respiration sensor, a blood pressure sensor, a body temperature sensor, an electroencephalogram sensor, a photoplethysmography sensor, a blood sugar sensor, and the like.

Finally, the sensing module 500 additionally adds a microphone 550, and an internal microphone 551 and an external microphone 552 are used for different purposes.

The internal microphone 551 may be used, for example, to analyze a voice of the passenger in the autonomous vehicle 1000 based on AI or the like or to immediately respond to a direct voice command.

On the other hand, the external microphone 552 may be used for analyzing various sounds generated from the outside of the autonomous vehicle 1000 using various analysis tools such as deep learning and responding appropriately thereto for safe travel or the like.

For reference, components shown in FIG. 2 may perform the same or similar functions as those shown in FIG. 1, and FIG. 2 illustrates relative positional relationships of the components (based on the interior of the autonomous vehicle 1000) in more detail compared to FIG. 1.

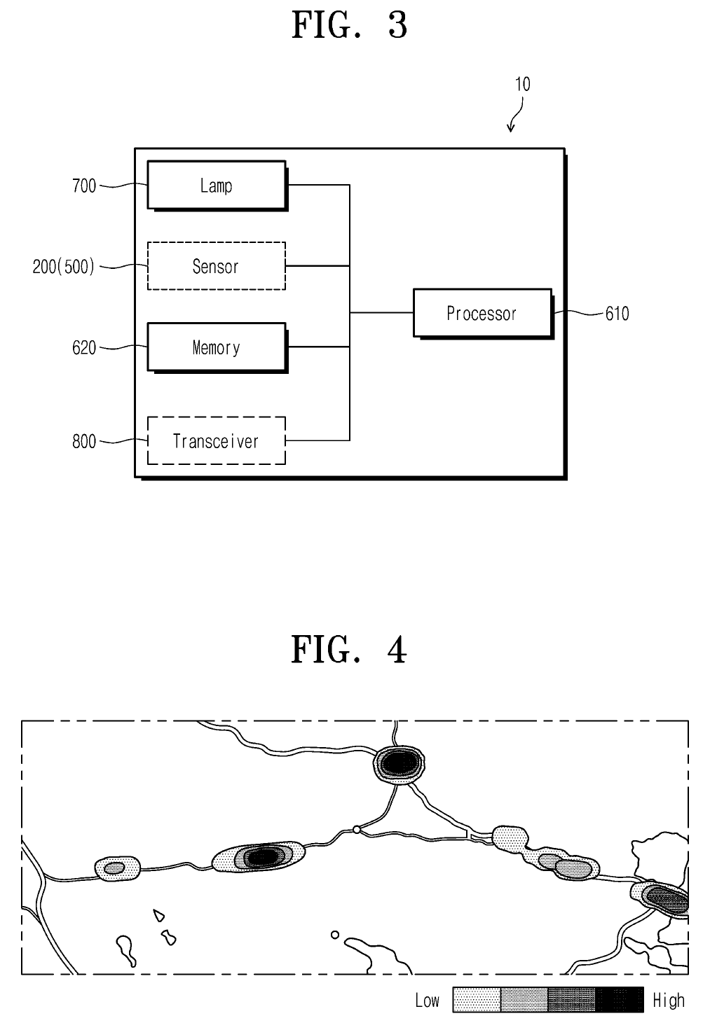

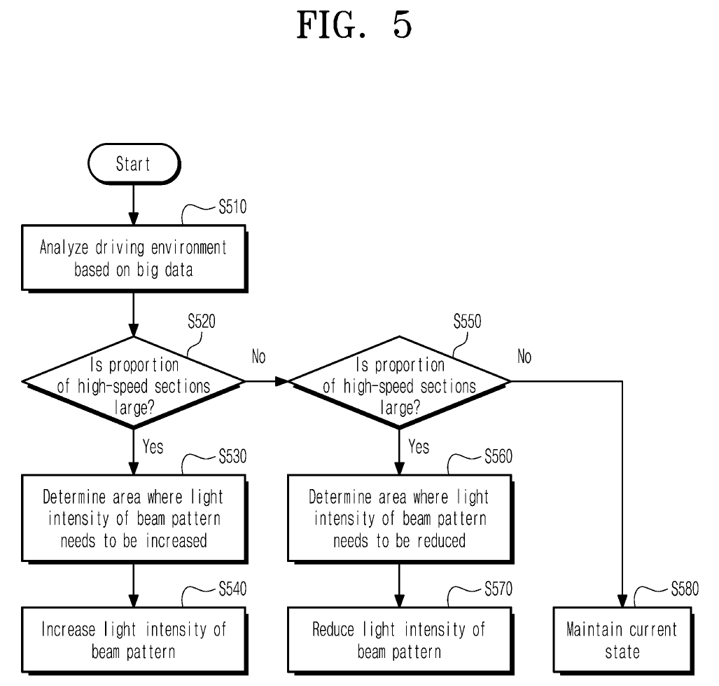

FIG. 3 is a block diagram of a lamp control system according to embodiments. FIG. 4 illustrates data obtained by collecting and analyzing the usage history of a specific beam pattern of multiple moving objects based on location information.

The lamp control system 10 may include a lamp 700, a memory 620, and a processor 610. The lamp control system 10 is included in a moving object 1000 and may be mounted or installed on the moving object 1000. In the present disclosure, a moving object refers to an object with mobility as a means of transportation and may include, for example, vehicles, drones, robots, and the like.

The lamp 700, as a kind of output unit that irradiates a beam in a forward direction of the vehicle based on a beam pattern, may include a pair of lamps. More specifically, the lamp 700 may be a kind of a headlamp, composed of a pair of headlamps on left and right portions of the front surface of the moving object (or vehicle). In general, the headlamp or a headlight may include a low beam, a high beam, a turn signal, a daytime running light, a side light, and the like.

The memory 620 may store the driving environment data of the moving object 1000. Additionally or alternatively, the memory 620 may store refined data by analyzing driving environment data.

Here, the driving environment data may be linked to driving distance information or driving time information. That is, the driving environment data may include driving environment data based on driving distance or driving time.

More specifically, the driving environment data may be linked to the distance information of a driving section. For example, the driving environment data may be linked to distance (location) information such as road section information, latitude, and longitude information of the driving section.

In addition, the driving environment data may be linked to the time information of the driving section. For example, the driving environment data may be linked to the time information (i.e., the specific hour and minute) when the driving section was passed.

In addition, the memory 620 may store big data obtained by collecting and analyzing the driving environment data of multiple moving objects based on location information. That is, the memory 620 may store the driving environment data of the moving object 1000 or refined data by analyzing the driving environment data. Additionally or alternatively, the memory 620 may store big data obtained by collecting and analyzing the driving environment data of multiple moving objects besides the moving object 1000 based on the location information of the multiple moving objects.

The lamp control system 10 may be configured to receive driving environment data from a server. That is, the server may collect navigation information of the currently driving moving object 1000 or GPS information related to the moving object 1000, advanced driver assistance system (ADAS) related information on the moving object 1000, or output interface information for vehicle control of the moving object 1000, and store, analyze, process, or manage the information.

The driving environment data based on location information or time information may include big data obtained by collecting and analyzing the driving distances of multiple moving objects based on location information or time information. The server may collect driving distance information and driving time information of multiple moving objects for each section and analyze the information to construct big data. An example of big data related to driving distance based on location information according to the embodiments is shown in FIG. 4.

Referring to FIG. 4, it is seen that the average (or median) of driving distances is marked on the map with hatching. The information shown in FIG. 4 is obtained by collecting, analyzing, and refining the driving distances of multiple moving objects.

The present disclosure proposes adjusting the beam pattern of the lamp according to the driving environment of the moving objects for each section. Accordingly, effects such as increasing or alleviating the concentration or fatigue of drivers may be expected.

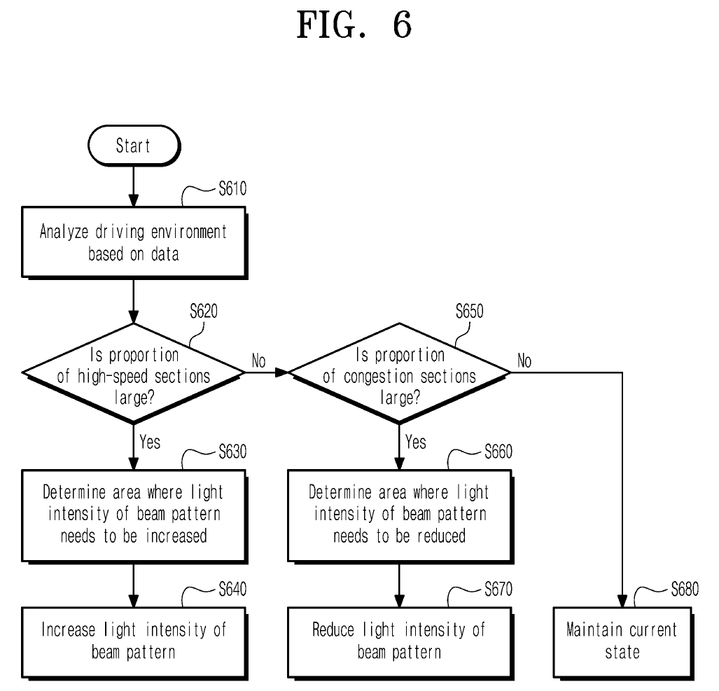

The processor 610 may be configured to control the lamp 700 based on the driving environment-related data of the moving object 1000 stored in the memory 620 or big data obtained by analyzing the driving environment-related data of multiple moving objects. More specifically, the processor 610 may control the light intensity or beam width of the beam pattern emitted by the lamp 700. The control of the light intensity or beam width of the beam pattern by the processor 610 will be explained in detail with reference to FIGS. 5 and 6.

Thus, the processor 610 may be configured to collect driving environment data based on the driving of the moving object 1000. Additionally, the processor 610 may be configured to store the collected driving environment data in the memory 620. The processor 610 may be configured to adjust the beam pattern of the lamp 700 based on the driving environment data of the moving object 1000 stored in the memory 620.

As another embodiment, the processor 610 may be configured to collect driving environment data based on the driving of the moving object 1000 along with driving distance information or driving time information related to the driving. Additionally, the processor 610 may be configured to store the collected driving environment data and the related driving distance information or driving time information in the memory 620. The processor 610 may be configured to adjust the beam pattern of the lamp 700 based on the driving environment data of the moving object 1000 and the related driving distance information or driving time information stored in the memory 620.

Additionally, when driving environment-related data is linked to driving distance information or driving time information, the processor 610 may acquire the location information of the moving object 1000 or the time information at the corresponding location. The location information of the moving object 1000 may be acquired by sensors 200. In this case, the processor 610 may be configured to control the lamp 700 based on the location information of the moving object 1000 or the current time information, along with the driving environment data based on driving distance or driving time stored in the memory 620. More specifically, the processor 610 may be configured to adjust the beam pattern of the lamp 700.

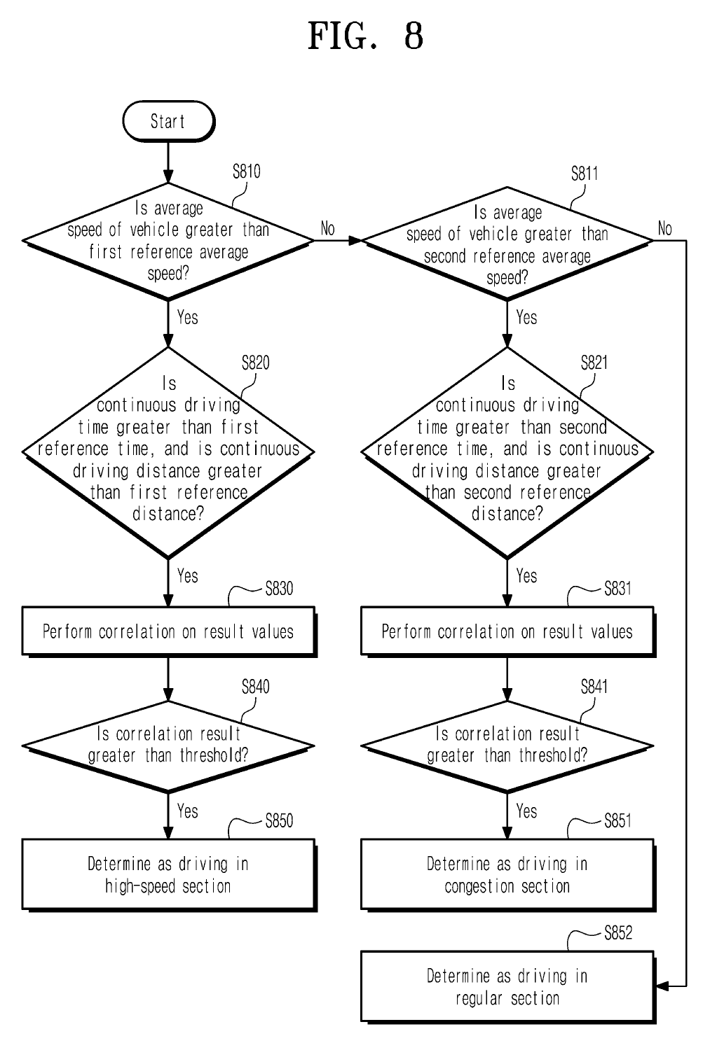

The lamp control system 10 may further include sensors 200 or 500. The sensors may include sensors 210, 220, 230, 240, 250, and 260 configured to acquire information related to the driving of the moving object or sensors 510, 520, 530, and 540 configured to acquire information related to the surroundings of the moving object. The current location information of the moving object 1000 may be acquired through the sensors. Additionally, information fundamental to the driving environment data may be acquired through the sensors 200 or 500. This will be explained in detail provided with reference to FIG. 8.

The lamp control system 10 may further include a transceiver 800. The transceiver 800 may be configured to receive driving distance data from the server. Additionally, the transceiver 800 may be configured to transmit the driving environment data of the moving object 1000, on which the lamp control system 10 is mounted or installed, to the server. Here, the driving environment data may be linked to driving distance information or driving time information.

FIGS. 5 and 6 are flowcharts of methods of controlling a beam pattern according to embodiments. More specifically, FIG. 5 shows a flowchart of a method for controlling a beam pattern based on big data acquired according to embodiments. FIG. 6 shows a flowchart of a method for controlling a beam pattern based on acquired data according to embodiments.

FIGS. 5 and 6 show methods by which the vehicle in FIGS. 1 and 2 or the lamp control system 10 in FIG. 3 controls the lamp based on the autonomous driving integrated controller 600 in FIGS. 1 and 2 or the processor 610 in FIG. 3.

The lamp control method according to the embodiments may include: acquiring the driving environment data of the moving object 1000, refined data by analyzing the driving environment data of the moving object 1000, or big data obtained by collecting and analyzing the driving environment data of multiple moving objects based on location information; and controlling a beam pattern based on either the acquired big data or data along with the location information of the moving object 1000.

More specifically, the lamp control system 10/lamp control method according to the embodiments may determine whether the big data is acquired, that is, whether the big data is available for use. If it is determined that the big data is available, the lamp control system 10/lamp control method may analyze the driving environment based on the acquired big data as shown in FIG. 5 (S510). As described in FIGS. 3 and 4, the big data may correspond to refined big data obtained by acquiring, collecting, and analyzing the driving environment data of the corresponding moving object 1000 as well as other multiple moving objects. That is, the lamp control system 10/lamp control method according to the embodiments may analyze the driving environment of a section that the moving object 1000 is currently driving in based on the refined big data related to other multiple moving objects and the location information of the moving object 1000 (S510).

First, the lamp control system 10/lamp control method according to the embodiments may determine whether the driving environment analyzed in step S510 has a large proportion of high-speed sections (S520). In this case, the high-speed section may be determined based on the ratio of driving time and driving distance in the big data. For example, if it is determined based on the big data that the distance of the driving section is relatively long, but the time taken to drive the section is relatively short compared to the distance, it may be determined that the driving section corresponds to the high-speed section.

If it is determined in step S520 that the current driving section of the moving object 1000 has a large proportion of high-speed sections, the lamp control system 10/lamp control method according to the embodiments may determine the corresponding section as an area where the light intensity of the beam pattern needs to be increased (S530). In this case, in step S530, it may be determined whether to increase the light intensity or the beam width of the beam pattern. Then, the lamp control system 10/lamp control method according to the embodiments may increase the light intensity or beam width of the beam pattern (S540).

In other words, if the current driving section of the moving object 1000 has a large proportion of high-speed sections, the lamp control system 10/lamp control method according to the embodiments has the effect of increasing the long-distance visibility of the driver by improving the light intensity or beam width of the beam pattern.

On the other hand, if it is determined in step S520 that the current driving section of the moving object 1000 does not have a large proportion of high-speed sections, the lamp control system 10/lamp control method according to the embodiments may determine whether the driving environment analyzed in step S510 has a large proportion of congestion sections (S550). In this case, the congestion section may be determined based on the ratio of driving time and driving distance in the big data. For example, if it is determined based on the big data that the distance of the driving section is relatively short, but the time taken to drive the section is relatively long compared to the distance, it may be determined that the driving section corresponds to a congestion section.

If it is determined in step S550 that the current driving section of the moving object 1000 has a large proportion of congestion sections, the lamp control system 10/lamp control method according to the embodiments may determine the corresponding section as an area where the light intensity of the beam pattern needs to be reduced (S560). In this case, in step S560, it may be determined whether to reduce the light intensity or the beam width of the beam pattern. Then, the lamp control system 10/lamp control method according to the embodiments may reduce the light intensity or beam width of the beam pattern (S570).

In other words, if the current driving section of the moving object 1000 has a large proportion of congestion sections, the lamp control system 10/lamp control method according to the embodiments has the effect of reducing power consumption by reducing the light intensity or beam width of the beam pattern.

Additionally, if it is determined in step S550 that the current driving section of the moving object 1000 does not have a large proportion of congestion sections, the lamp control system 10/lamp control method according to the embodiments may maintain the current state without controlling the beam pattern of the lamp 700 (S580). In other words, if it is determined in step S520 that the proportion of high-speed sections is not large and simultaneously in step S550 that the proportion of congestion sections is not large, the driving environment analyzed in step S510 may be considered as a regular section that is neither a high-speed section nor a congestion section.

Therefore, the lamp control system 10/lamp control method according to the embodiments has the effect of efficiently controlling the lamp 700 based on the characteristics of the driving section, using the big data collected based on the driving environment data of not only the moving object 1000 but also other multiple moving objects.

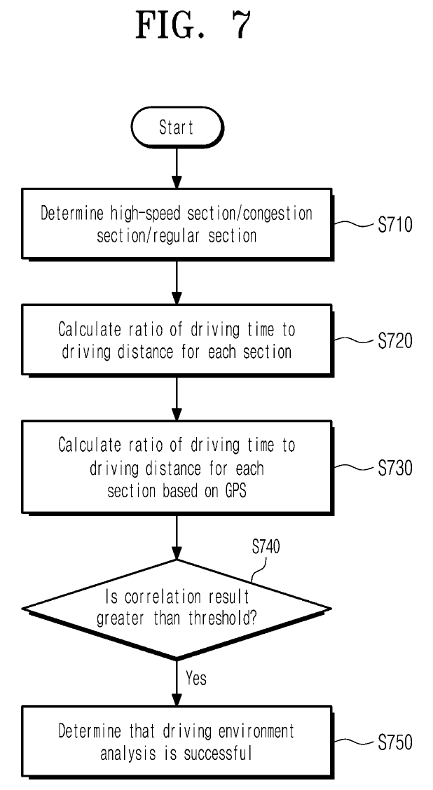

Unlike FIG. 5, if it is determined that the use of the big data is not possible as shown in FIG. 6, the lamp control system 10/lamp control method according to the embodiments may analyze the driving environment based on the acquired driving environment data of the moving object 1000 or refined data based on the driving environment data (S610). That is, if the use of the refined big data related to other multiple moving objects is not possible, the lamp control system 10/lamp control method according to the embodiments may analyze the driving environment of the current driving section of the moving object 1000 based on the driving environment data of the moving object 1000 and the location information of the moving object 1000 (S610). Step S610 will be explained in more detail in FIG. 7.

Similar to the case of using big data, the lamp control system 10/lamp control method according to the embodiments may determine whether the driving environment analyzed in step S610 has a large proportion of high-speed sections (S620). In this case, the high-speed section may be determined based on the ratio of driving time and driving distance in the acquired driving environment data of the moving object 1000. The principles for determining the high-speed section will be explained in more detail in FIG. 8.

If it is determined in step S620 that the current driving section of the moving object 1000 has a large proportion of high-speed sections, the lamp control system 10/lamp control method according to the embodiments may determine the corresponding section as an area where the light intensity of the beam pattern needs to be increased (S630). In this case, in step S630, it may be determined whether to increase the light intensity or the beam width of the beam pattern. Then, the lamp control system 10/lamp control method according to the embodiments may increase the light intensity or beam width of the beam pattern (S640).

In other words, if the current driving section of the moving object 1000 has a large proportion of high-speed sections, the lamp control system 10/lamp control method according to the embodiments has the effect of increasing the long-distance visibility of the driver by improving the light intensity or beam width of the beam pattern.

On the other hand, if it is determined in step S620 that the current driving section of the moving object 1000 does not have a large proportion of high-speed sections, the lamp control system 10/lamp control method according to the embodiments may determine whether the driving environment analyzed in step S610 has a large proportion of congestion sections (S650). In this case, the congestion section may be determined based on the ratio of driving time and driving distance in the acquired driving environment data of the moving object 1000. The principles for determining the congestion section will be explained in more detail in FIG. 8, along with the principles for determining the high-speed section.

If it is determined in step S650 that the current driving section of the moving object 1000 has a large proportion of congestion sections, the lamp control system 10/lamp control method according to the embodiments may determine the corresponding section as an area where the light intensity of the beam pattern needs to be reduced (S660). In this case, in step S660, it may be determined whether to reduce the light intensity or the beam width of the beam pattern. Then, the lamp control system 10/lamp control method according to the embodiments may reduce the light intensity or beam width of the beam pattern (S670).

In other words, if the current driving section of the moving object 1000 has a large proportion of congestion sections, the lamp control system 10/lamp control method according to the embodiments has the effect of reducing power consumption by reducing the light intensity or beam width of the beam pattern.

Additionally, if it is determined in step S650 that the current driving section of the moving object 1000 does not have a large proportion of congestion sections, the lamp control system 10/lamp control method according to the embodiments may maintain the current state without controlling the beam pattern of the lamp 700 (S680). In other words, if it is determined in step S620 that the proportion of high-speed sections is not large and simultaneously in step S650 that the proportion of congestion sections is not large, the driving environment analyzed in step S610 may be considered as a regular section that is neither a high-speed section nor a congestion section.

Therefore, even when the use of the big data is not possible, the lamp control system 10/lamp control method according to the embodiments has the effect of efficiently controlling the lamp 700 based on the characteristics of the driving section using the driving environment data of the moving object 1000.

FIG. 7 illustrates a detailed flowchart of step S610 step shown in FIG. 6, which is part of the lamp control method according to the embodiments. More specifically, FIG. 7 shows a flowchart for analyzing the driving environment based on the acquired data, as part of the method for controlling the beam pattern according to the embodiments.

FIG. 7 is a method by which the vehicle in FIGS. 1 and 2 or the lamp control system 10 in FIG. 3 controls the lamp based on the autonomous driving integrated controller 600 in FIGS. 1 and 2 or the processor 610 in FIG. 3.

Referring to FIG. 7, the lamp control system 10/lamp control method according to the embodiments may first determine whether the current driving section of the moving object 1000 corresponds to a high-speed section, a congestion section, or a regular section (S710). More specifically, in step S710, information about the driving section may be determined based on the acquired driving environment data of the moving object 1000 and the refined data obtained from the acquired driving environment data. The principles for this determination will be explained in more detail in FIG. 8.

Furthermore, the lamp control system 10/lamp control method according to the embodiments may calculate the ratio of driving time and driving distance for each section based on the information about the driving section determined in step S710 (S720). Additionally, the lamp control system 10/lamp control method according to the embodiments may calculate the ratio of driving time and driving distance for each section based on Global Positioning System (GPS) data simultaneously with, after, or before step S720 (S730). The ratio of driving time and driving distance for each section based on GPS may include information obtained on the basis of location information and speed information acquired using GPS, which have been collected while the moving object is (currently) traveling.

In step S720, the correlation between the ratio of driving time and driving distance for each section calculated in step S720 and the ratio of driving time and driving distance for each section calculated in step S730 may be analyzed, and it may be determined whether the correlation result exceeds a threshold (S740).

If it is determined in step S740 that the correlation result exceeds the threshold, the analysis of the driving environment is considered successful, and the lamp control system 10/lamp control method according to the embodiments may use the analyzed driving environment (S750). On the other hand, if it is determined in step S740 that the correlation result does not exceed the threshold, the analysis of the driving environment is considered unsuccessful, and the lamp control system 10/lamp control method according to the embodiments may again determine whether the current driving section of the moving object 1000 corresponds to a high-speed section, a congestion section, or a regular section (S710).

Instead of directly determining the information about the driving section based solely on the acquired driving environment data of the moving object 1000, the lamp control system 10/lamp control method according to the embodiments determines the information about the driving section based on the relationship with the ratio of driving distance and driving time for each section acquired via GPS, thereby enhancing the reliability of the analyzed driving environment results.

FIG. 8 is a detailed flowchart of step S710 shown in FIG. 7, which is part of the lamp control method according to the embodiments. More specifically, FIG. 8 shows a flowchart for analyzing the driving section based on the acquired data, as part of the method for controlling the beam pattern according to the embodiments.

FIG. 8 illustrates a method by which the vehicle in FIGS. 1 and 2 or the lamp control system 10 in FIG. 3 controls the lamp based on the autonomous driving integrated controller 600 in FIGS. 1 and 2 or the processor 610 in FIG. 3.

Referring to FIG. 8, the lamp control system 10/lamp control method according to the embodiments may first determine whether the current average speed of the moving object 1000 is greater than a first reference average speed (S810).

If it is determined in step S810 that the current average speed of the moving object 1000 is greater than the first reference average speed, the lamp control system 10/lamp control method according to the embodiments may determine whether the time the moving object 1000 has been driving continuously is greater than a first reference time and whether the distance the moving object 1000 has been driving continuously is greater than a first reference distance (S820).

If it is determined in step S820 that the time the moving object 1000 has been driving continuously is greater than the first reference time and, at the same time, the distance the moving object 1000 has been driving continuously is greater than the first reference distance, the correlation between the continuous driving time information and continuous driving distance information may be analyzed, and it may be determined whether the correlation result exceeds a threshold (S840).

On the other hand, if it is determined in step S820 that the time the moving object 1000 has been driving continuously is not greater than the first reference time, or the distance the moving object 1000 has been driving continuously is not greater than the first reference distance, the analysis of the driving environment is considered unsuccessful, and the lamp control system 10/lamp control method according to the embodiments may again determine whether the current average speed of the moving object 1000 is greater than the first reference average speed (S810).

If it is determined in step S840 that the correlation result exceeds the threshold, the analysis of the driving environment is considered successful, and the lamp control system 10/lamp control method according to the embodiments may determine that the current driving section corresponds to a high-speed section (S850). On the other hand, if it is determined in step S840 that the correlation result does not exceed the threshold, the analysis of the driving environment is considered unsuccessful, and the lamp control system 10/lamp control method according to the embodiments may again determine whether the current average speed of the moving object 1000 is greater than the first reference average speed (S810).

Alternatively, if it is determined in step S810 that the current average speed of the moving object 1000 is not greater than the first reference average speed, the lamp control system 10/lamp control method according to the embodiments may determine whether the current average speed of the moving object 1000 is smaller than a second reference average speed (S811). In this case, the second reference average speed may have a smaller value than the first reference average speed.

If it is determined in step S811 that the current average speed of the moving object 1000 is smaller than the first reference average speed, the lamp control system 10/lamp control method according to the embodiments may determine whether the time the moving object 1000 has been driving continuously is smaller than a second reference time and whether the distance the moving object 1000 has been driving continuously is smaller than a second reference distance (S821). In this case, the second reference time may have a smaller value than the first reference time, and the second reference distance may have a smaller value than the first reference distance.

If it is determined in step S821 that the time the moving object 1000 has been driving continuously is smaller than the second reference time and, at the same time, the distance the moving object 1000 has been driving continuously is smaller than the second reference distance, the correlation between the continuous driving time information and continuous driving distance information may be analyzed, and it may be determined whether the correlation result exceeds a threshold (S841).

On the other hand, if it is determined in step S821 that the time the moving object 1000 has been driving continuously is not smaller than the second reference time, or the distance the moving object 1000 has been driving continuously is not smaller than the second reference distance, the analysis of the driving environment is considered unsuccessful, and the lamp control system 10/lamp control method according to the embodiments may again determine whether the current average speed of the moving object 1000 is greater than the first reference average speed (S810).

If it is determined in step S841 that the correlation result exceeds the threshold, the analysis of the driving environment is considered successful, and the lamp control system 10/lamp control method according to the embodiments may determine that the driving section corresponds to a congestion section (S851). On the other hand, if it is determined in step S841 that the correlation result does not exceed the threshold, the analysis of the driving environment is considered unsuccessful, and the lamp control system 10/lamp control method according to the embodiments may again determine whether the current average speed of the moving object 1000 is greater than the first reference average speed (S810).

Additionally, if it is determined in step S811 that the current average speed of the moving object 1000 is not smaller than the first reference average speed, the lamp control system 10/lamp control method according to the embodiments may determine that the current driving section of the moving object 1000 corresponds to a regular section (S852), neither a high-speed section nor a congestion section.

Therefore, instead of directly determining the information about the driving section based on the acquired driving environment data of the moving object 1000, the lamp control system 10/lamp control method according to the embodiments may analyze the correlation between the driving distance and driving time in the driving environment data, thereby increasing the reliability of the analyzed driving environment results

The embodiments have been described in terms of the method and/or the device, and the descriptions of the method and the device may be applied in a complementary manner.

For convenience of description, the description has been made with the respective drawing, but it is also available to design a new embodiment by combining the embodiments described with the respective drawings to each other. In addition, designing a computer-readable recording medium in which a program for executing the embodiments described above is recorded based on needs of a person skilled in the art is also within the scope of the embodiments. In the device and the method according to the embodiments, the configurations and the methods of the embodiments as described above may not be applied in a limited manner, but all or some of the embodiments may be selectively combined with each other such that various modifications may be made. Although the preferred embodiments of the embodiments have been illustrated and described, the embodiments may not be limited to the specific embodiments described above, various modifications may be made by a person skilled in the art to which the invention pertains without departing from the gist of the embodiments claimed in the claims, and such modifications should not be individually understood from the technical ideas or prospects of the embodiments.

The various components of the device of the embodiments may be implemented by hardware, software, firmware, or combinations thereof. The various components of the embodiments may be implemented via a single chip, for example, a single hardware circuit. Depending on the embodiments, the components of the embodiments may be implemented via separate chips. Depending on the embodiments, at least one of the components of the device of the embodiments may be composed of one or more processors that may execute one or more programs, and the one or more programs may perform, or include instructions for performing, one or more of the operations/methods according to the embodiments. Executable instructions for performing the methods/operations of the device of the embodiments may be stored in a non-transitory CRM or other computer program products built to be executed by the one or more processors, or may be stored in a transitory CRM or other computer program products built to be executed by the one or more processors. In addition, the memory of the embodiments may be used as a concept including not only a volatile memory (e.g., a RAM or the like), but also a non-volatile memory, a flash memory, a PROM, and the like. Additionally, the memory may include implementations in a form of carrier wave, such as transmission via the Internet. Additionally, a processor-readable recording medium may store processor-readable code in a distributed manner across a computer system connected via a network, allowing the code to be executed in a distributed fashion.

In this document, "/" and "," are interpreted as "and/or." For example, "A/B" is interpreted as "A and/or B," and "A, B" is interpreted as "A and/or B." Additionally, "A/B/C" means "at least one of A, B, and/or C." Also, "A, B, C" means "at least one of A, B, and/or C." Additionally, "or" in this document is interpreted as "and/or." For example, "A or B" may mean 1) "A" only, 2) "B" only, or 3) "A and B". In other words, "or" in this document may mean "additionally or alternatively."

Terms such as first, second, and the like may be used to describe various components of the embodiments. However, the various components according to the embodiments should not be limited in their interpretation by these terms. These terms are merely used to distinguish one component from another. For example, a first user input signal may be referred to as a second user input signal. Similarly, the second user input signal may be referred to as the first user input signal. The use of these terms should be interpreted as not departing from the scope of the various embodiments. Although the first user input signal and the second user input signal are both user input signals, they do not mean the same user input signal unless the context clearly indicates otherwise.

The terminology used to describe the embodiments is for the purpose of describing particular embodiments and is not intended to be limiting of the embodiments. As used in the description of the embodiments and in the claims, the singular expression is intended to include the plural expression unless the context clearly dictates otherwise. The expression "and/or" is used to have a meaning including all possible combinations of the terms. The expression "include" describes the presence of features, numbers, steps, elements, and/or components, but does not mean that additional features, numbers, steps, elements, and/or components are not included. Conditional expressions such as "in case of ~," "when ~," and the like used to describe the embodiments are not interpreted as being limited to only optional cases. Rather, they are intended to mean that, when specific conditions are satisfied, corresponding operations are performed, or relevant definitions are interpreted accordingly.

In addition, the operations according to the embodiments described in this document may be performed by a transceiver including the memory and/or the processor according to the embodiments. The memory may store programs for processing/controlling the operations according to the embodiments, and the processor may control the various operations described in this document. The processor may be referred to as a controller or the like. The operations according to the embodiments may be performed by firmware, software, and/or combinations thereof, and the firmware, the software, and/or the combinations thereof may be stored in the processor or in the memory.

In one example, the operations according to the embodiments described above may be performed by a transmitter and/or a receiver according to the embodiments. The transceiver may include a transceiver unit that transmits and receives media data, a memory that stores instructions (program codes, algorithms, flowcharts, and/or data) for a process according to the embodiments, and a processor that controls operations of the transceiver.

The processor may be referred to as the controller or the like, and may correspond to, for example, hardware, software, and/or combinations thereof. The operations according to the embodiments described above may be performed by the processor. In addition, the processor may be implemented as an encoder/decoder or the like for the operations of the embodiments described above.

As described above, the relevant content has been described in the best mode for carrying out the embodiments.

As described above, the embodiments may be applied entirely or partially to autonomous valet driving device and system.

Those skilled in the art may make various changes or modifications to the embodiments within the scope of the embodiments.

The embodiments may include the changes/modifications, and the changes/modifications may not depart from the scope of the claims and equivalents thereof.

What is claimed is:

1. A lamp control system for a moving object, comprising:
a lamp configured to emit a beam pattern;
a memory configured to store driving environment data of the moving object, data obtained by refining and analyzing the driving environment data of the moving object, and big data obtained by collecting and analyzing driving environment data of a plurality of other moving objects based on location information; and
a processor configured to control the beam pattern based on one of the big data, the driving environment data of the moving object and the data derived from the driving environment data, and location information of the moving object.

2. The lamp control system of claim 1, wherein the driving environment data comprises driving distance information or driving time information of the moving object for each section corresponding to the driving environment data.

3. The lamp control system of claim 1, wherein the processor is configured to control the beam pattern based on driving section information of the moving object corresponding to the location information of the moving object, and
wherein the driving section information is indicated by one of the big data, the driving environment data and the data derived from the driving environment data.

4. The lamp control system of claim 3, wherein the processor is configured to:
in a case in which the driving section information indicated by one of the big data, the driving environment data and the data derived from the driving environment data corresponds to first section information, control to increase a light intensity or beam width of the beam pattern; and
in a case in which the driving section information indicated by one of the big data, the driving environment data and the data derived from the driving environment data corresponds to second section information, control to reduce a light intensity or beam width of the beam pattern.

5. The lamp control system of claim 1, wherein the processor is configured to control the beam pattern based on correlation information between first driving section information of the moving object and second driving section information, the first driving section information corresponding to the location information of the moving object indicated by the driving environment data or the data derived from the driving environment data and the second driving section information being based on global positioning system (GPS).

6. The lamp control system of claim 5, wherein the driving section information is configured based on information on an average speed of the moving object, information on a continuous driving distance for each section, or information on a continuous driving time for each section, and
wherein the information on the continuous driving distance for each section and the information on the continuous driving time for each section are included in the driving environment data corresponding to the location information of the moving object.

7. The lamp control system of claim 6, wherein the driving section information is configured based on correlation information between the information on the continuous driving distance for each section and the information on the continuous driving time for each section.

8. The lamp control system of claim 1, wherein the processor is configured to:
in a case in which the big data is available, control the beam pattern based on the big data; and
in a case in which the big data is unavailable, control the beam pattern based on the driving environment data or the data derived from the driving environment data.

9. A lamp control method for a moving object, performed by a lamp control system having a lamp configured to emit a beam pattern in a forward direction, and the method comprising:
acquiring one or more of driving environment data of the moving object, data obtained by refining and analyzing the driving environment data of the moving object, and big data obtained by collecting and analyzing driving environment data of a plurality of other moving objects based on location information; and
controlling the beam pattern based on one of the big data, the driving environment data of the moving object and the data derived from the driving environment data, and location information of the moving object.

10. The lamp control method of claim 9, wherein the driving environment data comprises driving distance information or driving time information of the moving object for each section corresponding to the driving environment data.

11. The lamp control method of claim 9, further comprising:
controlling the beam pattern based on driving section information of the moving object corresponding to the location information of the moving object, and
wherein the driving section information is indicated by the big data or the data.

12. The lamp control method of claim 11, further comprising:
in a case in which the driving section information indicated by one of the big data, the driving environment data and the data derived from the driving environment data corresponds to first section information, controlling to increase a light intensity or beam width of the beam pattern; and
in a case in which the driving section information indicated by the big data, the driving environment data and the data derived from the driving environment data corresponds to second section information, controlling to reduce a light intensity or beam width of the beam pattern.

13. The lamp control method of claim 9, further comprising:
controlling the beam pattern based on correlation information between first driving section information of the moving object and second driving section information, the first driving section information corresponding to the location information of the moving object indicated by the driving environment data or the data derived from the driving environment data and the second driving section information being based on global positioning system (GPS).

14. The lamp control method of claim 13, wherein the driving section information is configured based on information on an average speed of the moving object, information on a continuous driving distance for each section, or information on a continuous driving time for each section, and
wherein the information on the continuous driving distance for each section and the information on the continuous driving time for each section are included in the driving environment data corresponding to the location information of the moving object.

15. The lamp control method of claim 14, wherein the driving section information is configured based on correlation information between the information on the continuous driving distance for each section and the information on the continuous driving time for each section.

16. The lamp control method of claim 9, further comprising:
in a case in which the big data is available, controlling the beam pattern based on the big data; and
in a case in which the big data is unavailable, controlling the beam pattern based on the data.

17. A moving object comprising:
a lamp configured to emit a beam pattern;
a memory configured to store driving environment data of the moving object, data obtained by refining and analyzing the driving environment data of the moving object, and big data obtained by collecting and analyzing driving environment data of a plurality of other moving objects based on location information; and
a processor configured to control the beam pattern based on one of the big data , the driving environment data of the moving object and the data derived from the driving environment data, and location information of the moving object.

18. The moving object of claim 17, wherein the driving environment data comprises driving distance information or driving time information of the moving object for each section corresponding to the driving environment data.

19. The moving object of claim 17, wherein the processor is configured to control the beam pattern based on driving section information of the moving object corresponding to the location information of the moving object, and
wherein the driving section information is indicated by one of the big data, the driving environment data and the data derived from the driving environment data.

20. The moving object of claim 19, wherein the processor is configured to:
in a case in which the driving section information indicated by one of the big data, the driving environment data and the data derived from the driving environment data corresponds to first section information, control to increase a light intensity or beam width of the beam pattern; and
in a case in which the driving section information indicated by one of the big data, the driving environment data and the data derived from the driving environment data corresponds to second section information, control to reduce a light intensity or beam width of the beam pattern.
